(19) United States
(12) Patent Application Publication
(10) Pub. No.: US 2001/0005281 A1
(43) Pub. Date: Jun. 28, 2001

(54) Optical system for increasing contrast of object viewed through it

(76) Inventor: Caroline Yu, New York, NY (US)

Correspondence Address: Joy I. Farber, Esq., Cohen, Pontani, Lieberman & Pavane, Suite 1210, 551 Fifth Avenue, New York, NY, 10176, US

(21) Appl. No.: 09/776,401

(22) Filed: Feb. 2, 2001

Related U.S. Application Data
(63) Continuation-in-part of application No. 09/371,377, filed on Aug. 10, 1999.

(30) Foreign Application Priority Data
Aug. 8, 1999 (US) PCT/US00/40596

(51) Int. Cl. G02B 23/00; G02B 5/30; G02B 27/28

(52) U.S. Cl. 359/400; 359/437; 359/482; 359/483; 359/808

(57) ABSTRACT

An optical system for providing a viewer with contrast between a golf ball and its environment, including a light filter and at least one polarizer mounted in a viewing device. The light filter has no more than about 20% transmittance of light in one of the range of wavelengths of from about 500 nm to about 700 nm. The viewing device allows for the light filter and the polarizer to be arranged in front of at least one eye of the viewer. The optical system can be provided in a spotting scope, a pair of eyeglasses or an attachment to eyeglasses for ease of use.

### BACKGROUND OF THE INVENTION

1. Field of the Invention

The present invention relates to an optical system for increasing the contrast of an object viewed through it, thereby enabling the viewer to selectively locate the object in its surroundings. Especially advantageous is the incorporation of a spotting scope or monocular as part of the optical system in order to provide magnification and create a greater contrast between a golf ball (generally white) and its golf course environment. This contrast helps the user find his or her golf ball more easily.

2. Description of the Related Art

Recreational golf is a popular sport in which the golfer attempts to hit a small, usually white golf ball into a distant hole. Golf courses typically have challenging terrain which makes this feat difficult, including various twists and turns in terrain, interrupted by various obstacles such as trees, sand traps, and the like. More often than desired, a golfer who has intended to hit a ball, for example straight down a fairway, will miss his mark. When this happens, it is often difficult to find the location of the ball and resume play. Although sunglasses and hats bearing visors generally assist in reducing glare from sunlight, these articles do little to help render the ball visible on the green or in other vegetation. Furthermore, magnifying devices may assist in improving distance viewing but provide little or no assistance in providing contrast between the ball and its surroundings.

Certain devices are known to provide enhanced color perception and/or to reduce glare. U.S. Pat. No. 5,218,386 describes an apparatus for increasing perception of the color of an object. The apparatus comprises one optical filter worn over the left eye and provided with spectral response having three peaks, one each for red, green and blue tuned to the maximum responsiveness of the eye to those colors. Another optical filter worn over the right eye is similar to the first filter, but has peaks tuned to complementary portions of the visual spectrum.

U.S. Pat. No. 5,363,152 describes a pair of eyeglasses for enhancing the true color of an object. The eyeglasses have lenses, one of which has a filter to prevent a predetermined portion of reflected light from the object from entering one eye while allowing a second predetermined portion of the reflected true color of an object to enter the other eye, thereby enhancing the true color of the object.

U.S. Pat. No. 5,408,278 describes eyeglasses for enhancing visual and color perception. The eyeglasses have specially balanced and integrated lens pairs, one lens allowing transmission of light predominantly from the shorter half of the visible spectrum (400 to 550 nm) and the other lens allowing transmission from the longer half of the visible spectrum (from 550 to 750 nm), that are used to subtract specific quantities of selected visible light from the ambient input to each of the two eyes.

U.S. Pat. No. 5,592,245 describes an apparatus for enhancing the perception of a yellow tennis ball that comprises an optical filter through which the viewer views the tennis ball. The filter has a pronounced peak transmittance around 500 to 600 nanometers that passes a high percentage of incident light reflected and fluoresced by the tennis ball, but passes a substantially lower percentage of light in the remaining portion of the visible spectrum.

U.S. Pat. No. 5,646,781 describes an optical filter to provide an enhanced image. The filter comprises a substrate including a substantially transparent material, the substrate having a first surface and a multilayer coating on the first surface of the substrate, the multilayer coating including first layers of a first transmissive material having a high index of refraction and second layers of a second transmissive material having a low index of refraction, wherein the first layers have an optical thickness greater than the optical thickness of the second layers, the optical filter blocking passbands substantially centered at 490 nm and 590 nm.

Although known lens designs provide enhanced perception of certain colors, they do not solve the problems faced by a golfer in locating a lost golf ball. In light of the increasing popularity in the sport, and the consequent crowded conditions of golf courses, there is a present need for a viewing or optical system to enhance a viewer's ability to quickly locate lost golf balls and thus be able to resume play more quickly.

### SUMMARY OF THE INVENTION

It is an object of the present invention to provide an optical system for increasing the contrast of an object viewed through it.

It is another object of the present invention to provide an optical system for locating a golf ball against its grassy surroundings.

It is a further object of the present invention to provide an optical system for locating a golf ball in a spotting scope, thereby better enabling the viewer to locate the object in its surroundings.

It is a still further object of the present invention to provide an optical system for locating a golf ball in the convenient form of eyeglasses.

These objects and others that will become apparent from the following specification are achieved by providing an optical system having a selective optical wavelength filtering characteristic for increasing a contrast between a white object (i.e., a golf ball) and a vegetation (i.e., grass and/or forested) background. For example, the filter blocks green or green-yellow light wavelengths generally within the range of light wavelengths of about 500 to 600 nm. In addition, at least one polarizer or polarizing filter is provided for blocking glare which also serves to enhance color contrast.

Preferably, the optical system for increasing the contrast of an object viewed through it comprises in combination at least one lens, at least one polarizer, and a filter blocking light in the range of wavelengths of from about 450 to about 650 nm, i.e., a green or green-yellow blocking filter, such as, for example, a red, magenta, or blue pass filter. The filter preferably has a uniform optical retardance in order to avoid birefringent effects from the polarizer.

The filters may be absorption filters or dichroic filters. One preferred filter type is therefore a green blocking (magenta) dichroic filter. Alternatively, a preferred absorptive filter is a WRATTEN #32 filter. A third type of preferred filter is an optical glass filter exhibiting little to no transmittance in the wavelength range of from about 500 to about 550 nm.

The filter may be a magenta filter having a pass wavelength band of about 300 to about 500 nm and about 600 to about 750 nm or the filter may be a blue filter having a pass wavelength band of about 300 to about 500 nm, having a relatively high attenuation at visible wavelengths outside the pass wavelength band. The stop or blocked band wavelengths which include an approximately green and/or green yellow light should be blocked so that no more than about 20% of light in the stop band is transmitted. Preferably, no more than about 10% of light in the stop band should be transmitted. More preferably no more than about 5% of light in the stop band should be transmitted, and most preferably substantially no light in the stop band is transmitted.

In a particularly preferred embodiment, the optical system includes a blue light filter effective in blocking light wavelengths from about 500 to 650 nm (i.e., SCHOTT BG-3, available from Schott Glass Technologies, Inc., Duryea, Pa., USA).

In different seasons, the vegetation may include differing predominant characteristic wavelengths. The optical filters may therefore be changed or adjusted for maximum contrast for the particular conditions. It has been found that, although a magenta (pass) filter is advantageous when the vegetation is lush, when the vegetation is wooded or is subjected to dry conditions, a blue (pass) filter may be preferred. A significant factor in the success of the filter is that sufficient contrast be maintained. To this end, it is preferable to have a pass band that transmits a relatively large fraction of light, (i.e., about 90% or greater transmittance) while having a stop band that transmits a small fraction of light (i.e., approximately zero transmittance). For example, a pass band to stop band ratio of the optical filter of at least about 4 is preferred. In other words, a greater differential between the light transmittance in the pass band to stop band is preferred to provide the greatest contrast.

An alternative embodiment to the use of colored glass filters is the use of a clear glass substrate provided with a thin film and/or reflective coating effective to stop transmission in the approximately green and/or green/yellow wavelengths. One or more colored glass filter and/or coated glass filter may be used alone or in appropriate combinations. Optionally, the filter may also comprise an electrooptic element or turntable filter.

One or more polarizers may be used. Polarizers of any type, including variable polarizers and the like may be used. Preferably, there are three polarizers arranged in series with the two outer polarizers having their polarization axes inclined at about 90° with respect to one another, while the polarization axis of the middle polarizer is at about a 45°angle to that of the other two filters.

An optical system in which the lens is part of a multi-lens non-inverting optical system, such as a known spotting scope is preferred. Such an optical system may also contain a reticle, illuminator, range finder (e.g., laser, optical or triangulation), magnifier, roof prism or other features known in the art.

In another embodiment, the optical system may contain a binocular pair of lenses, each set in an eyeglass frame, each lens having a vegetation suppressing optical filter and a polarizer, or an integral optical filter and polarizer.

In another embodiment, a set of “clip-on” eyeglasses is provided having a vegetation filtering color and polarization.

In a still further embodiment, a pair of eyeglasses is provided having an optical filter tuned to block predominant vegetation reflections, for example from grass, and having an optical polarizer in front (away from the eye) which can be adjusted together for optimum glare reduction.

In contrast to normal sunglasses, the optical filtering according to the present invention typically provides a wider separation between the optical pass band and stop band. Since the typical object to be seen is a bright white (golf ball), the amount of attenuation in the pass band is less critical than the difference in attenuation between the pass band and stop band.

Normal sunglasses are intended for extended use by the viewer, while optical systems according to other embodiments of the present invention are intended for short term intermittent viewing, and therefore of a duration sufficiently short so that the human visual system does not fully accommodate for the effect. These embodiments therefore encompass the spotting scope and temporary eyeglass “clip-on” embodiments.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, in which like reference characters denote similar elements throughout the several views:

FIG. 1 illustrates an embodiment the optical system of the present invention including a pair of eyeglasses;

FIG. 2 illustrates an embodiment of the optical system of the present invention including a spotting scope;

FIG. 3 illustrates an embodiment of the optical system of the present invention including an auxiliary device and a spotting scope; and

FIG. 4 is a graphical representation of the transmittance of a preferred blue light filter used in an embodiment of the present invention.

### DETAILED DESCRIPTION OF THE PRESENTLY PREFERRED EMBODIMENTS

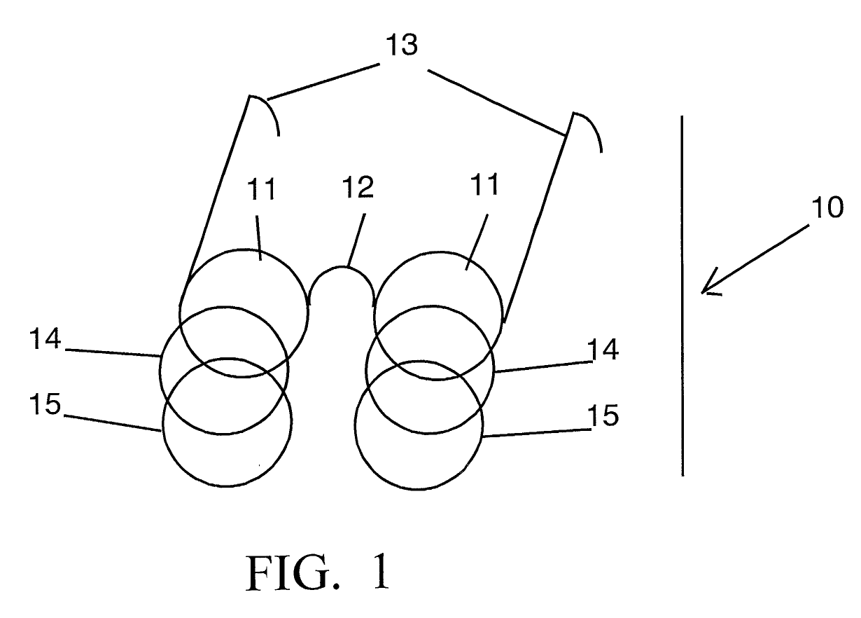

FIG. 1 illustrates one embodiment of the optical system 10 of the invention (everything to the left of the vertical line indicated by “10”). Corrective or plano lenses 11 are set in an eyeglass frame 12, which has side frames 13. In front of lenses 11 are at least one pair of filters 14 with no more than about 20% transmittance of light in the range of wavelengths of from about 500 nm to 700 nm. Preferably, the pair of filters 14 substantially blocks light in the range of wavelengths of from about 500 nm to about 620 nm. In front of the filters 14 are at least one pair of polarizers 15. The filters 14 and polarizers 15 may be made to clip-on the glasses. When the intended user does not wear corrective lenses, 11 represents openings in the frame in which filters 14 and polarizers 15 may be mounted.

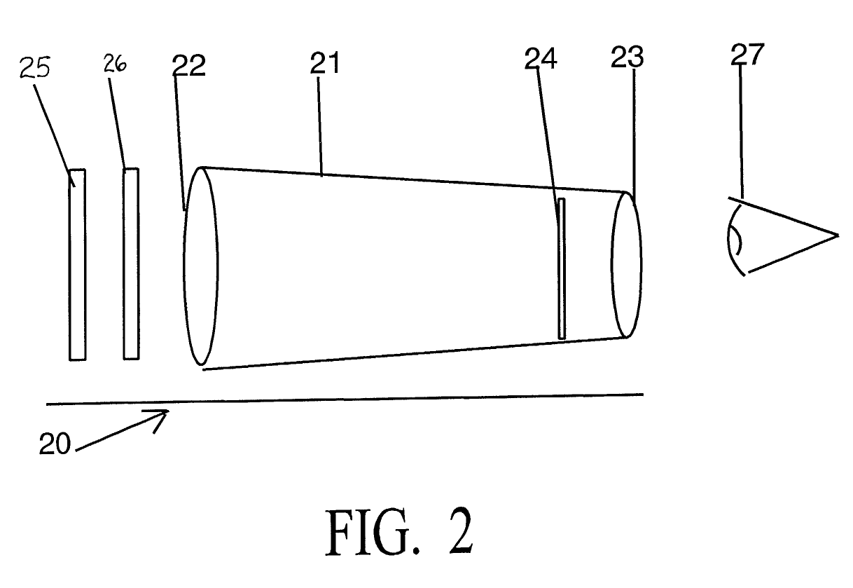

FIG. 2 illustrates another embodiment of the optical system 20 of the present invention (everything above the horizontal line indicated by “20”). A spotting scope 21 has an objective lens 22 at its left end and an eyepiece lens 23 at its right end. A reticle 24 is located inside the spotting scope 21 toward the end with the eyepiece lens 23. In front of the objective lens 22 is a light filter 26, and in front of the filter 26 is a polarizer 25. The viewer's eye is indicated at 27. The light filter 26 is effective in blocking substantially all light in the range of wavelengths of from about 500 nm to 700 nm. Alternatively, the light filter 26 is effective in transmitting substantially all light in the range of wavelengths of from about 300 nm to about 500 nm and from about 600 nm to about 750 nm.

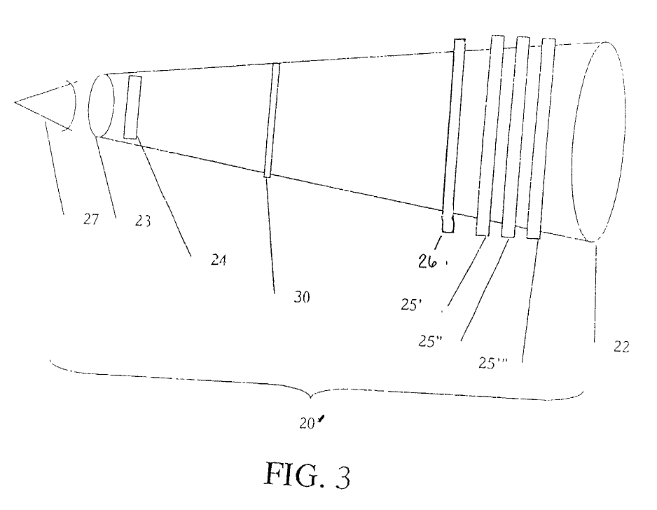

FIG. 3 illustrates a alternative optical system 20′ according to the present invention. The viewer's eye is indicated at 27. The spotting scope 20′ includes an objective lens 22, an eyepiece lens 23, and a reticle 24, as in the embodiment shown in FIG. 2. In the present embodiment, the color filter 26 is interposed between the three polarizers 25′, 25″, 25″′ in series and the reticle 24. The polarizers 25′, 25″, 25″′ are arranged such that the two outer polarizers 25′, 25″ have their polarization axes inclined at about 90° with respect to one another, while the polarization axis of the middle polarizer 25″ is at about a 45° angle to that of the other two polarizers 25′, 25″′. In addition, an auxiliary device 30 is interposed between the reticle 24 and the polarizers 25′, 25″, 25″′. The auxiliary device 30 may be an illuminator, a range finder (e.g., laser, optical or triangulation), a magnifier, or other features known in the art. In a particularly advantageous embodiment of the present invention, the spotting scope has a magnification of between about 5× to about 7×, with a 50 mm objective lens 22. It should be noted that there are no particular limitations to the order of the auxiliary device(s) 30, polarizer(s) 25, and light filter 26.

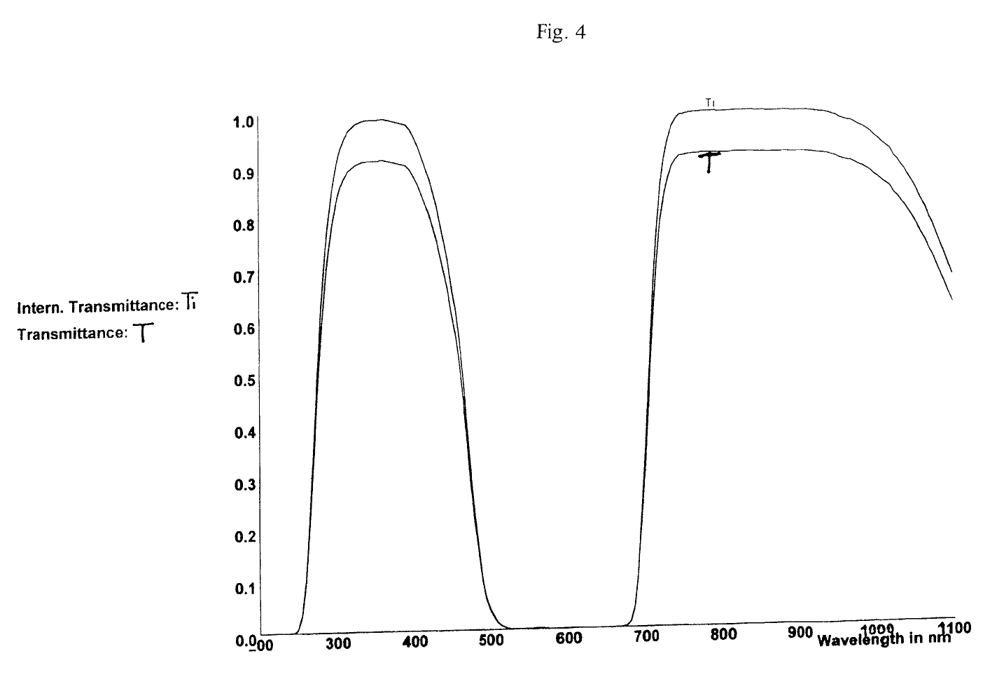

FIG. 4 is a graphical representation of the light transmittance curve for a particularly preferred light filter, the BG-3 by SCHOTT.

Table I summarized some of the filter/polarizer combinations that were tested and the results obtained from those tests. WRATTEN filters and Orion filters used are absorption filters, and the Lee and Roscolux filters used are interference or dichroic filters. The polarizers used were Tiffen polarizers.

| Filters/Polarizer combination | Observation |
|---|---|
| Magenta WRATTEN # 32 filter | Makes green and brown appear slightly darker and the |
| | white ball appear a little violet. Provides modest |
| | contrast. |
| Magenta dichroic (LEE filter # 113, LEE filter # 046, | Makes green and brown appear slightly darker and the |
| or ROSCOLUX filter # 46 | white ball appear a little violet. Provides modest |
| | contrast. |
| Magenta WRATTEN #32 with a polarizer | Makes green and brown appear very dark while |
| | allowing the white ball to stand out. Provides excellent |
| | contrast and is a preferred lens combination. |
| Magenta dichroic (LEE filter # 113, LEE filter # 046, | Makes green and brown appear very dark while |
| or ROSCOLUX filter # 46) with a polarizer | allowing the white ball to stand out. Provides excellent |
| | contrast and is a preferred lens combination. |
| Red orion # 25 with a polarizer | Makes green and brown appear darker, but also makes |
| | the white ball appear slightly darker and reddish. |
| | Provides an increase in contrast which is not as good as |
| | that provided by the magenta filters. |
| Red dichroic filter (LEE filter # 26 or ROSCO # 6500) | Makes green and brown appear darker, but also makes |
| with a polarizer | the white ball appear slightly darker and reddish. |
| | Provides an increase in contrast which is not as good as |
| | that provided by the magenta filters. |
| Violet orion # 47 with a polarizer | Makes all colors appear dark and provides only a low |
| | degree of separation of the white ball from its |
| | environment. |
| Orange orion # 21 with a polarizer | Makes the green grass appear relatively light and |
| | provides modest contrast against the golf ball. |
| Orange LEE filter # 105 with a polarizer | Makes the green grass appear relatively light and |
| | provides modest contrast against the golf ball. |
| Blue orion # 38A with a polarizer | Makes all colors appear darker and does not make the |
| | white ball stand out much against green vegetation. |
| | The white ball has a bluish tint. The blue does provide |
| | good contrast of a golf ball against yellowish grass or |
| | wooded or brown vegetation. |
| Blue dichroic LEE filter # 119 with a polarizer | Makes all colors appear darker and does not make the |
| | white ball stand out much against green vegetation. |
| | The white ball has a bluish tint. The blue does provide |
| | good contrast of a golf ball against yellowish grass or |
| | wooded or brown vegetation. |
| SCHOTT BG-3 and a series of 3 polarizers | Makes all colors appear darker and makes the white |
| | ball stand out against green vegetation. The white ball |
| | has a bluish tint. Provides good contrast of a golf ball |
| | against yellowish grass or wooded or brown |
| | vegetation. A preferred embodiment of the invention. |

Thus, while there have been shown and described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. All such changes, modifications, variations and other uses and applications which do not depart from the spirit and scope of the invention are deemed to be covered by the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An optical system for providing a viewer with contrast between a golf ball and its environment, comprising:
at least one light filter having no greater than about twenty percent transmittance of light in the range of wavelengths of from about 500 nm to about 700 nm;
at least one polarizer; and
viewing means for holding the light filter and the polarizer so as to be arrangeable in front of at least one eye of the viewer.

2. The optical system according to claim 1, wherein the light filter has no greater than about ten percent transmittance of light in the range of wavelengths of from about 500 nm to about 700 nm.

3. The optical system according to claim 1, wherein the light filter has no greater than about five percent transmittance of light in the range of wavelengths of from about 500 nm to about 700 nm.

4. The optical system according to claim 1, wherein the light filter has no greater than substantially zero transmittance of light in the range of wavelengths of from about 500 nm to about 700 nm.

5. The optical system according to claim 1, wherein the light filter comprises a clear glass substrate having a thin film coating.

6. The optical system according to claim 1, wherein the viewing means is selected from the group consisting of a spotting scope, a pair of eyeglasses, and an attachment to a pair of eyeglasses.

7. The optical system according to claim 1, wherein the at least one polarizer includes a first polarizer, a second polarizer, and a third polarizer arranged in series, each polarizer having an axis of polarization, wherein the polarization axes of the first polarizer and the third polarizer are inclined at about a 90° angle with respect to one another, the polarization axis of the second polarizer is at about a 45°angle with respect to the axes of polarization of the first polarizer and the third polarizer.

8. The optical system according to claim 1, wherein the light filter has substantially no transmittance of light in the range of wavelengths of from about 500 nm to about 650 nm.

9. The optical system according to claim 7, wherein the light filter has no greater than about twenty percent transmittance of light in the range of wavelengths of from about500 nm to about 650 nm.

10. The optical system according to claim 9, wherein the light filter has no greater than about ten percent transmittance of light in the range of wavelengths of from about 500 nm to about 650 nm.

11. The optical system according to claim 9, wherein the light filter has no greater than about five percent transmittance of light in the range of wavelengths of from about 500 nm to about 650 nm.

12. The optical system according to claim 9, wherein the light filter has substantially no transmittance of light in the range of wavelengths of from about 500 nm to about 650 nm.

13. The optical system according to claim 9, wherein the light filter has no greater than about twenty percent transmittance of light in the range of wavelengths of from about 500 nm to about 550 nm.

14. The optical system according to claim 9, wherein the light filter has no greater than about ten percent transmittance of light in the range of wavelengths of from about 500 nm to about 550 nm.

15. The optical system according to claim 1, wherein the light filter has no greater than about five percent transmittance of light in the range of wavelengths of from about 500 nm to about 550 nm.

16. The optical system according to claim 1, wherein the light filter has substantially no transmittance of light in the range of wavelengths of from about 500 nm to about 550 nm.

17. The optical system according to claim 1, further comprising:
at least one auxiliary device selected from the group consisting of a reticle, a rangefinder, an illuminator, a roof prism and a magnifier.

18. An optical system for providing a viewer with contrast between a golf ball and its environment, comprising:
a lens system including at least one light filter, at least one polarizer and an objective lens in series, wherein the light filter has substantially no transmittance of light in one of the range of wavelengths of from about 500 nm to about 700 nm; and
a viewing device selected from the group consisting of a spotting scope, a pair of eyeglasses, and an eyeglass attachment, wherein the lens system is mounted in the viewing device.

19. The optical system according to claim 18, wherein the light filter has substantially no transmittance of light on the range of wavelengths of from about 500 nm to about 650 nm.

20. The optical system according to claim 18, wherein the at least one polarizer includes a first polarizer, a second polarizer, and a third polarizer arranged in series, each polarizer having an axis of polarization, wherein the polarization axes of the first polarizer and the third polarizer are inclined at about a 90° angle with respect to one another, the polarization axis of the second polarizer is at about a 45° angle with respect to the axes of polarization of the first polarizer and the third polarizer.
